(19) United States
(12) Patent Application Publication
(10) Pub. No.: US 2024/0415712 A1
(43) Pub. Date: Dec. 19, 2024

(54) Stand Assist System

(71) Applicant: Direct Supply, Inc., Milwaukee, WI (US)

(72) Inventors: Shawn Ostendorf, Milwaukee, WI (US); Justin Morgan, Cedarburg, WI (US); Anthony Patrick, Delafield, WI (US); Joshua Jakubowski, Port Washington, WI (US); Brennen Beck, Mulwaukee, WI (US)

(21) Appl. No.: 18/667,317

(22) Filed: May 17, 2024

Related U.S. Application Data
(60) Provisional application No. 63/467,174, filed on May 17, 2023.

(51) Int. Cl. A61G 5/14

(52) U.S. Cl. CPC A61G 5/14

(57) ABSTRACT

The present invention provides an assembly that is configured to assist a user sitting into and/or rising from a wheelchair. In one embodiment, each assembly has a mount configured to affix the housing of a respective assembly to a corresponding first or second arm of the wheelchair. A pivotable arm extends from the housing to a user grip, wherein the pivotable arm is configured to rotate about a longitudinal axis of the housing. A ratchet lock disposed within the housing is configured to engage the pivotable arm extending from the housing and provide the pivotable arm with at least three locking positions, and a linkage is configured to selectively disengage the ratchet lock upon user activation. Rotation of the pivotable arms allows the user grip to rotate from a raised position, an outer position or a lowered position. In another embodiment, the assembly is integrated into the arm tube of the wheelchair.

### CROSS REFERENCE TO RELATED APPLICATION

This application claims priority to U.S. Provisional Patent Application Ser. No. 63/467,174 filed on May 17, 2024, the entirety of which is incorporated herein by reference.

### BACKGROUND OF THE INVENTION

The present invention relates to a stand assist mechanism for use with a conventional wheelchair; and more specifically, relates to a hand operated pivoting stand assist mechanism to aid in the ingress and egress of a physically impaired individual from a wheelchair.

Conventional wheelchairs are commonly used to accommodate a variety of individual users, as well as intended to accommodate the different medical needs of those individuals. Some individuals that require the use of a wheelchair may experience difficulty sitting into, i.e., ingressing, the wheelchair and/or rising from, i.e., egressing, the wheelchair. Such difficulties may arise from generally decreased physical strength or a temporary injury or ailment. Regardless of the cause of the user's difficulty in ingressing/egressing the wheelchair, there remains the need to independently and securely assist in the transfer of a user to and from the seated position, without or in combination with the assistance of another person, such as a caregiver.

Conventional wheelchairs are designed with armrests that are positioned at or below standard desk-height of approximately 28 to 30 inches above ground. Such a configuration allows conventional wheelchairs to be positioned comfortably at a usable distance from a table or desk. Furthermore, the armrest of a conventional wheelchair is shortened towards the front of the wheelchair to provide the user with access to the braking mechanism located at the front of the wheels. Such an arrangement provides improper positioning of the hands when attempting to engage the armrests for ingress/egress. Namely, the user's hands are positioned both downwardly and rearwardly of a position that would provide increased ergonomic advantage for standing or sitting.

Prior attempts to assist in raising and lowering an individual into the seat of a wheelchair include the use of large elongated removable handles, which transition between a raised position extending at or near the chest of a standing wheelchair user, i.e., 15-24 inches above the armrest; to a stored position rotated approximately 180° such that the handles nearly contact the front wheels of the wheelchair. Such bulky devices are not only visually obtrusive, but in the raised position potentially inhibit a caregiver from accessing the user to provide assistance during wheelchair transfers. Furthermore, the handles of such systems are positioned above or forward to the front castor wheels of the wheelchair, such that their use results in an increase in front-tip hazard. Moreover, such attachments, even when in the stored position, inhibit the wheelchair from being positioned comfortably at or under and desk-height surface. Accordingly, there is need for a stand assist mechanism to aid in the ingress and egress of a physically impaired individual from a wheelchair, which may be installed on original wheelchairs or retrofitted onto preexisting wheelchairs. There is also a need for a stand assist mechanism that provides multiple operable positions to both provide improved ergonomic hand grip locations when in use and maintains desk-height accessibility of the wheelchair when stored.

### SUMMARY OF THE INVENTION

The present invention eliminates the need for bulky external devices to provide improved hand placement when ingressing and/or egressing the wheelchair while maintaining full wheelchair functionality.

In one embodiment, the present invention provides a first and second assembly that are each configured to assist a user sitting into and/or rising from a wheelchair. Each assembly may have a mounting surface configured to affix the housing of a respective assembly to a corresponding first or second arm member of the wheelchair. A pivotable arm extends from the housing to a user grip, wherein the pivotable arm is configured to rotate about a longitudinal axis of the housing. A ratchet lock disposed within the housing is configured to engage the pivotable arm extending from the housing and provide the pivotable arm with at least three locking positions, and a linkage is configured to selectively disengage the ratchet lock upon user activation. Rotation of the pivotable arms allows the user grip to rotate from a raised position, an outer position or a lowered position. In another embodiment, the assembly is integrated into the arm tube of the wheelchair.

The assembly may be provided as a retrofit to an existing wheelchair.

It is thus a feature of at least one embodiment of the invention to provide a mounting surface or mount that can be affixed to the arm tube of the wheelchair.

The assembly may provide a raised user grip for providing improved leverage when standing or ease of locating the chair within bending when sitting.

It is thus a feature of at least one embodiment of the invention to provide a first position of the pivotable arm being a raised position in which the user grip is disposed at a height greater than a height of the arm member or tube of the wheelchair.

The assembly may provide a wider or laterally spaced position for the user grip as to providing improved leverage when standing or wider base of hand support when sitting.

It is thus a feature of at least one embodiment of the invention to provide a second position of the pivotable arm being an outer position in which the user grip is disposed distally of the arm member or tube of the wheelchair.

The assembly may provide a lower position for the user grip as to allow the chair to be positioned at a conventional desk, table or seating surface without obstruction or interference of the user grips.

It is thus a feature of at least one embodiment of the invention to provide a third position being a lowered position in which the user grip is disposed at a height less than the height of the arm member or tube.

The assembly may provide for the use of gravitation force to return the user grips to the lower position, thereby providing one hand activation for each individual assembly.

It is thus a feature of at least one embodiment of the invention to provide a trigger in mechanical engagement with the linkage, wherein user activation of the trigger selectively disengages the ratchet lock as to allow the pivot arm to rotate from the first position to the second position, or the second position to the third position under gravitational force.

The assembly may provide for adjustability for various user heights and arm lengths.

It is thus a feature of at least one embodiment of the invention to provide a length of the pivotable arm that is telescopically adjustable.

The assembly may be provided within a wheelchair arm assembly without the need for external mounting or retrofitting.

It is thus a feature of at least one embodiment of the invention to provide a wheelchair arm in which a first or forward portion of the arm member defines the housing of the stand assist mechanism and a second or rearward portion of the arm member defines a tube configured as an arm rest.

These and other features and aspects of the present invention will be better appreciated and understood when considered in conjunction with the following description and the accompanying drawings. It should be understood, however, that the following description, while indicating representative embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

FIG. 1 is front side perspective view of a collapsible wheelchair in accordance with the prior art is shown;

FIG. 2 is a front side perspective view of a right-hand stand assist assembly in accordance with one embodiment of the present invention;

FIG. 3 is a right-side view of the stand assist assembly shown in FIG. 2;

FIG. 4 is a front elevation view of the stand assist assembly shown in FIG. 2;

FIG. 5 is a sectional right-side view of the stand assist assembly shown in FIG. 2;

FIG. 6 is a partial sectional right-side perspective view of the stand assist assembly shown in FIG. 2;

FIG. 7 is a front perspective view of a pair of right and left side stand assist assemblies, corresponding to the handle assembly shown in FIG. 2;

FIG. 8 is a front side perspective view of an alternative embodiment of a right-side stand assist assembly according to the present invention affixed to a removable arm of a wheelchair;

FIG. 9 is a rear perspective view of the right-side stand assist assembly affixed to a removable arm of a wheelchair shown in FIG. 8;

FIG. 10 is a front and left-side perspective photograph of a pair of stand assist assemblies according to one embodiment of the present invention affixed to a wheelchair, with the handle assemblies in the raised or “Up Position”;

FIG. 11 is a front and left-side perspective photograph of a pair of stand assist assemblies according to one embodiment of the present invention affixed to a wheelchair, with the handle assemblies in the laterally outward or “Out Position”;

FIG. 12 is a front and left-side perspective photograph of a pair of stand assist assemblies according to one embodiment of the present invention affixed to a wheelchair, with the handle assemblies in the lowered or “Down Position”;

FIG. 13 is a right-side perspective view of the push rod and gear configured to be disposed within the housing of the stand assist assembly shown in FIG. 2;

FIG. 14 is a perspective view of the gear configured to be disposed within the stand assist of the handle assembly shown in FIG. 2;

FIG. 15 is a perspective view of the push rod configured to be disposed within the stand assist of the handle assembly shown in FIG. 2; and,

FIG. 16 is a partial exploded front side perspective view of an alternative embodiment of a left-side arm member and mountings including a stand assist assembly according to the present invention configured to be received within a front portion of the arm member configured for use with a wheelchair.

### DETAILED DESCRIPTION

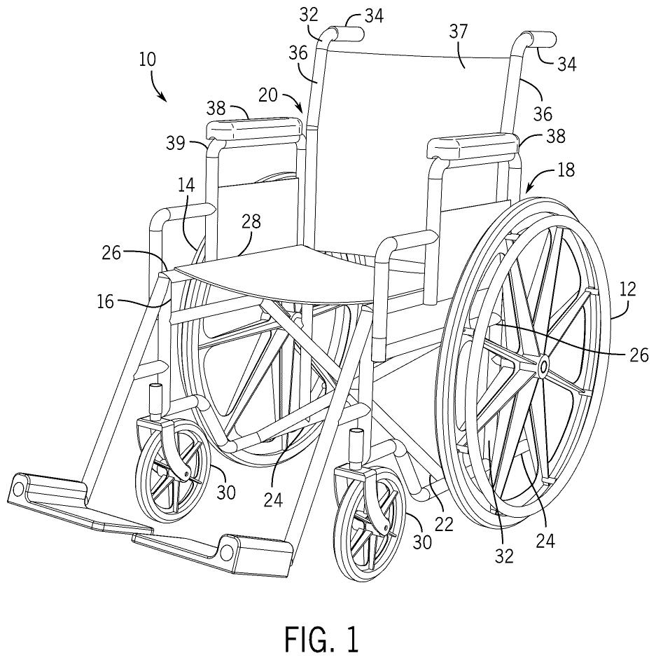

Referring initially to FIG. 1, a prior art collapsible wheelchair 10 is shown including a first wheel 12 and a second wheel 14 located on opposing sides of a frame 16. The frame 16 includes first side frame subassembly 18 adjacent the first wheel 12 and a second side frame subassembly 20 adjacent the second wheel 14. A cross frame 22 configured in the shape of an “X” extends between the first side frame subassembly 18 and the second side frame subassembly 20, wherein the cross frame 22 may pivot to collapse the wheelchair 10. Each of the first and second frame subassemblies 18, 20 further includes a first horizontal tube 24, affixed to a portion of the cross frame 22 at or near the bottom of the wheelchair frame 16, and a second horizontal tube 26, affixed to a second portion of the cross frame 22, above the first horizontal tube 24. In some embodiments, as shown in FIG. 1, each subassembly 18, 20 of the wheelchair frame 16 may also include a third horizontal tube 28, positioned adjacent to or slightly above the second horizontal tube 26, which may function as a seat retention device. The wheels 12, 14, are generally affixed to the relative subassembly 18, 20, at or near the rear end of the first horizontal tube 24, while a castor wheel 30 may extend from an opposing front end of the first horizontal tube 24. A standard lever actuated wheel lock 31 may be mounted at or near the second horizontal tube 26, where downward motion on the handle forces a locking bar 33 into frictional engagement with the outer surface of the corresponding wheel 12, 14. A vertical tube 32 generally extends perpendicular to the first, second and third horizontal tubes 24, 26, 28, from the rear end of the first horizontal tube 24 to a distance above the third horizontal tube 28. The vertical tube 32 may terminate in a push handle 34 and define an attachment location 36 along its length for the seat beck 37, generally at a height above the third horizontal tube 28. As shown in FIG. 1, an armrest 38, positing on an arm tube 39 may extend above the third horizontal tube 28, generally at a height between the fixed seat surface 40 and the push handles 34.

In accordance with the prior art wheelchair 10, shown in FIG. 1, the armrests 38 are often grasped by the user when ingressing and/or egressing the wheelchair 10. However, as was described above, some users may require additional assistance when transitioning from sitting or rising from the wheelchair.

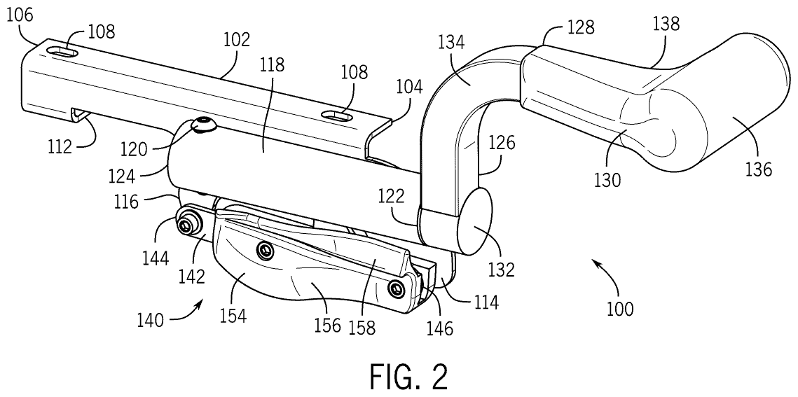

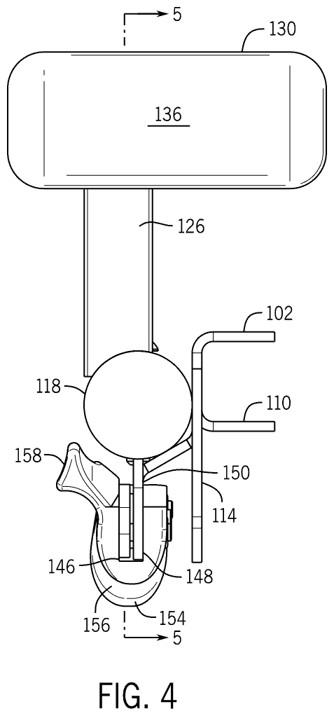

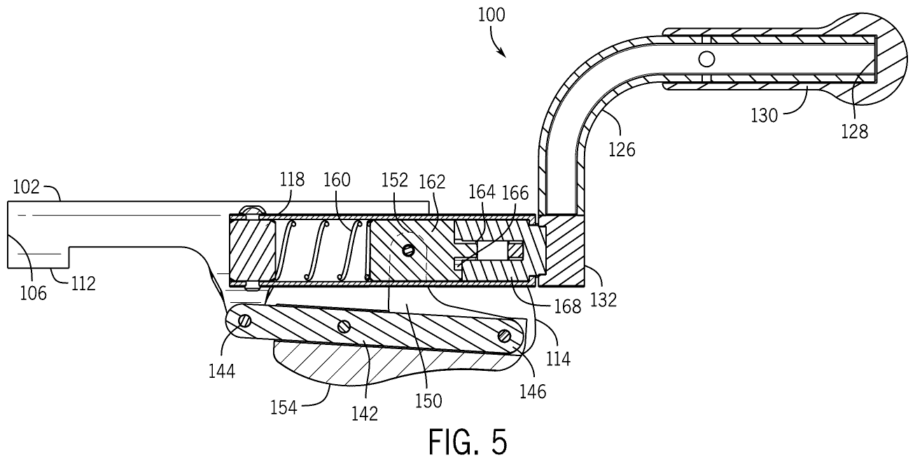

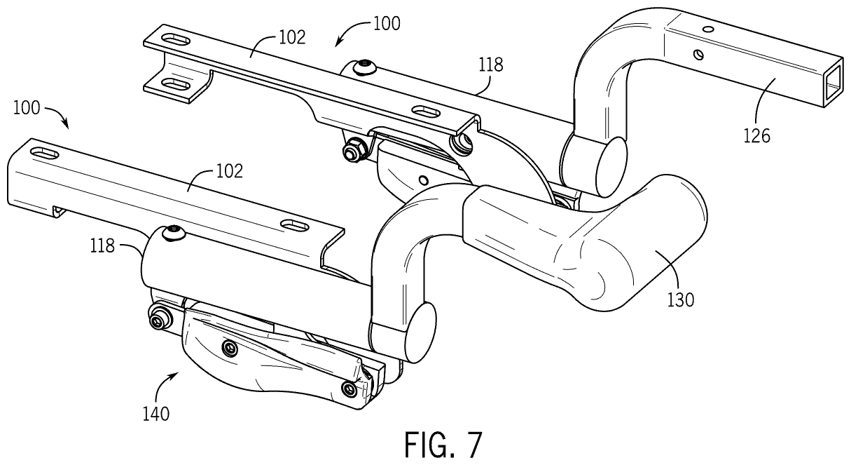

Turning now to FIGS. 2-9, and initially FIG. 2, in one embodiment, the present invention provides a handle assembly 100. While the assembly 100 shown in FIGS. 2-6, 8 and 9 are directed towards a single assembly 100, configured for use on the right-side arm rest 38 of a wheelchair 10, it should be understood the following description and present invention applies equally to a handle assembly configured for use on the left-side arm rest 38 of a wheelchair, and all reference numbers included herein are equally applicable in mirror-image.

The handle assembly 100 includes a mounting surface or arm 102 that extends from a front or first end 104 to a rear or second end 106. The length of the mounting arm 102 is configured to be received about or below the arm member or tube 39 of the wheelchair 10, which conventionally supports the armrest 38 thereon, wherein one or more apertures 108 disposed within the mounting arm 102 are configured to receive mounting hardware, such as a bolt, such as ones that would conventionally affix the armrest 38 to the arm tube 39 of the wheelchair 10, as shown in FIG. 1. Additional apertures 108, axially aligned with those in the mounting arm 102, may also extend from one or more bottom mounting tabs 112, which may be located adjacent the corresponding first and second ends of the mounting arm 102, in order to receive the mounting hardware and inhibit rotation of the handle assembly 100 about the arm tube 39. In accordance with this configuration, the mounting arm 102 is configured to be securely mounted to the arm tube 39 of a conventional wheelchair 10, including collapsible wheelchairs, such that the handle assembly 100 may be retrofitted onto a pre-existing wheelchair 10, include with a wheelchair as a kit, or alternatively incorporated directly into a wheelchair arm 38 during manufacture of the wheelchair 10. Alternatively, the mounting surface or arm 102 may be welded or otherwise affixed to the arm tube 39, without the use of external hardware.

Still referring to the mounting bar 102, forward of the first end 104, a first attachment tab 114 extends forwardly, generally perpendicular to the top surface of the mounting bar 102. A second attachment tab 116 also extends outwardly from the mounting bar 102, between the first and second bottom mounting tabs 110, 112. In combination, the first and second attachment tabs 114, 116 provide mounting location for a tube or housing 118 extending generally parallel to the longitudinal axis of the mounting bar 102. More specifically, as shown in FIGS. 2-7, one or more bolts 120, or alternative fasteners may secure the housing 118 to the corresponding mounting tab 114, 116.

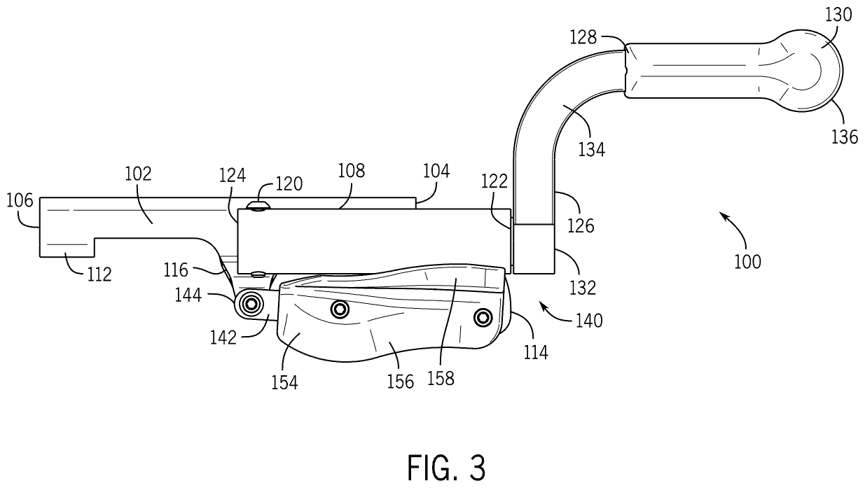

As shown in FIGS. 2 and 3, the front or first end 122 of the housing 118 extends forward of the first end 104 of the mounting bar 102, such that when installed on a wheelchair 10, the housing extends forwardly of the arm rest 38 affixed to the arm member 39. The opposing rear or second end 124 of the housing 118 is generally positioned at the second attachment tab 116, and secured thereto by fastener 120, located at or about midway between the first and second ends 104, 106 of the mounting bar 102.

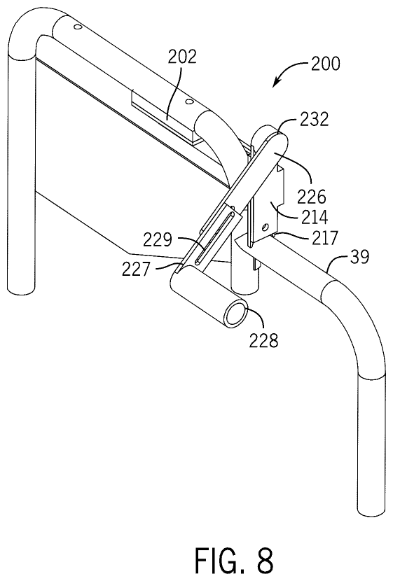

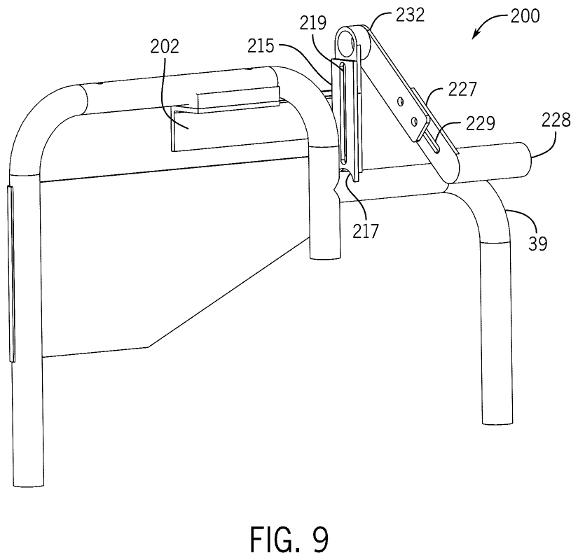

Still referring to FIGS. 2 and 3, an arm 126 is pivotably affixed to and extends forwardly of the first end 122 of the housing 118, and is configured to rotate about the longitudinal axis of the housing 118. The front or first end 128 of the arm 126 is configured to be affixed to or receive a hand grip 130 configured for a user to grasp as will be described in further detail below. The opposing rear or second end 132 of the arm 126 is configured to pivotably engage the first end 122 of the housing 118. As shown in FIGS. 2 and 3 the arm 126 may be curvilinear or bent, including a curved section 134 between opposing linear sections at first and second ends 128, 132. In such an embodiment, the linear section adjacent the second end 132 is generally positioned perpendicular to the longitudinal axis of the housing 118 and is configured to remain within that perpendicular plane during rotation about the first end 122 of the housing 118. In one embodiment of the present invention, as shown in FIGS. 2-7, the curved portion 134 of the arm 126 sweeps an angle of approximately 90°, such that the longitudinal axis of the linear portion of the arm 126 adjacent the first end 128 is generally positioned parallel to the longitudinal axis of the housing 118, throughout the arm's pivoting range of motion as will be described in further detail below. In an alternative embodiment, as shown in FIGS. 8 and 9, the arm 126 may lack a curved section 134, and rather comprise a linear section adjacent the second end 132 that is directly and perpendicularly affixed, via fastener, welding, or the like, to the linear portion of the arm 126 adjacent the first end 128.

As described above, the arm 126 is pivotably affixed about the first end 122 of the housing 118. More specifically, in one embodiment of the present invention, the arm 126 is configured to travel through a range of motion of less than or equal to 180°, and more preferably a range of motion that is less than 180° and more than or equal to 170°. Preferably the arm 126 has three operable and/or locking configurations or positions while traveling through that nearly 180° range of motion. However, it should be understood that any alternative range of rotational motion and operable configurations therein are considered well within the scope of the present invention.

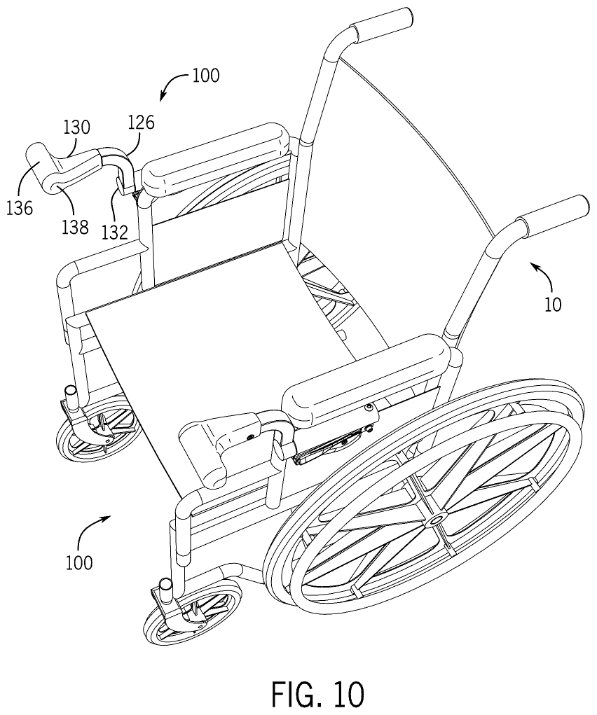

In a first configuration, as shown in FIGS. 2-7 and 10, and referred to herein as the “Up Position”, the linear section adjacent the second end 132 generally extends upwardly, such that the handle 130 is positioned at a height that is greater than the housing 118 and the arm member 139. The Up Position provides an elevated position for the hand grip 130 that is useful during ingress to allow the user to locate the wheelchair 10 while standing and without having to bend or crouch to grasp the relatively lower arm rests 38 of the conventional wheelchair 10. In the Up Position, the grip 130 is also positioned forward of the upper most portion of the arm member or tube 39, the desk length arm rests 38 of the conventional wheelchair 10, and generally rearwardly of a front edge of the front most vertical mounting tube of the arm member 39. As such the hand grip 130 will be positioned rearwardly of the caster wheels 30. The Up Position is also useful during egress from the wheelchair 10, as it provides a stabilizing position for the user's hands to engage a first grip surface of the hand grip 130, providing increased leverage through a pulling motion, rather than positioning their hands under their shoulders and pushing upwards on the arm rest 38 of the wheelchair 10.

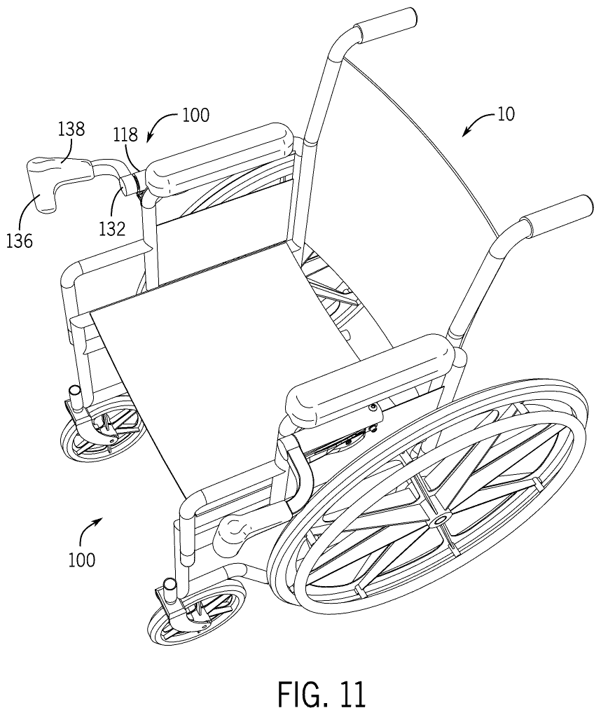

In a second configuration, as shown in FIG. 11, and referred to herein as the “Out Position”, the linear section adjacent the second end 132 is rotated approximately 90° downwardly from the Up Position, and generally extends outwardly of the housing 118, such that the grip 130 is positioned at a height that is approximately equal to housing 118 and the corresponding arm member 39. In this configuration, the Out Position is an intermediate configuration, positioned between the Up Position and the Down Position. The Out Position is useful during egress from the wheelchair 10, as it provides a wider positioned or distal location for the grip 130, which offers the user more leverage and improved ergonomic arm positioning offered though the overhand-style or second grip surface presented by the arm 126 in the Out Position than would be available when traditionally positioning their hands under their shoulders and pushing upwards on the arm rest 38 of the conventional wheelchair 10 in a traditional manner.

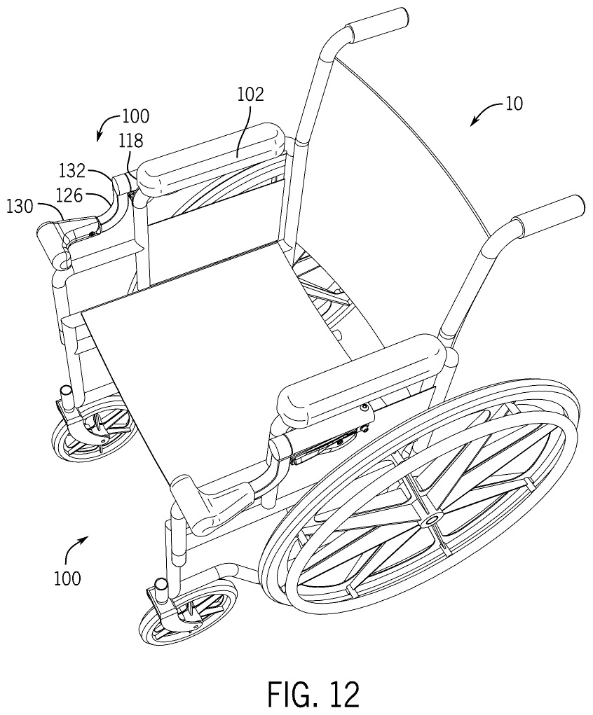

In a third configuration, as shown in FIGS. 8, 9 and 12, and referred to herein as the “Down Position”, the linear section adjacent the second end 132 has been rotated approximately 180° from the Up Position, and generally extends downwardly of the housing 118, such that the handle 130 is positioned at a height that is below the housing 118. The Down Position is useful for storing the handle assembly 100 when the user is not actively engaged in ingress or egress from the wheelchair 10. That is to say that in the Down Position, the arm 126 and grip 130 are positioned low enough for the wheelchair 10 to fit underneath a dining table, desk, or similar surface, with minimal change in the depth of the wheelchair 10 position relative to the corresponding table, desk or surface. More specifically, in the Down Position, the grip 130 is positioned at or below the height of a horizontal plane defined by an uppermost surface of the front, lower portion of the arm tube 39 of the desk length armrest assembly.

As described above and shown in FIGS. 2-7 and 10-12, the hand grip 130 may provide a primary surface 136 that extends generally perpendicular to the linear section of the arm 125 adjacent the first end 130 and is well suited for a user to engage when the assembly 100 is in the Up Position. In one embodiment of the present invention, as also shown in FIGS. 2-7 and 10-12 the handle grip 130 may be asymmetrically positioned about the linear section of the arm 125 adjacent the first end 130, such that in the Out Position, the grip 130 provides a secondary surface 138 that is upwardly facing.

As described above, the handle assembly 100 preferably has three operable configurations while traveling through that nearly 180° range of motion. To this end, handle assembly 100 further comprises a trigger assembly 140 that is configured to release the handle assembly 100 from any one of the three operable configurations and such that gravity may downwardly rotate the arm 126 from either the Up or Out Positions towards the Down Position or alternatively, the arm 126 may be manually rotate upward from the Down or Out Positions, towards the Up Position. Now referring again to FIGS. 2-7, the trigger assembly 140 includes a linkage 142 that is pivotably affixed at a first end 144 below the second end 124 of the housing 118 to the second attachment tab 116. The opposing second end 146 of the linkage 142, is pivotably affixed to the first end 148 of the connecting cam 150 which extends into the housing 118 and terminates at an opposing second end 152. A trigger handle 154 is disposed about a length of the linkage 142, between the opposing first and second ends 144, 146. In one embodiment of the present invention, the contoured outer surface of the trigger handle 154 provides a primary engagement surface 156 and a secondary engagement surface 158 (FIGS. 2-5), which allow multiple areas for user's grasping the trigger handle 154. Furthermore, the secondary engagement surface 158 may also extend upwardly as to provide a shroud or covering, inhibiting user engagement with the underlying linkage 142 and connecting cam 150 (i.e., inhibiting a pinch hazard between the linkage 142, or the connecting cam 150, and the housing 118). In use, upward pressure applied to the trigger handle 154 pivots the linkage 142 upwardly about its rear pivot point at the first end 144. This upward pivot of the linkage 142 translates to a rearward travel of the second end 152 of the connecting cam 150, located within the housing 118.

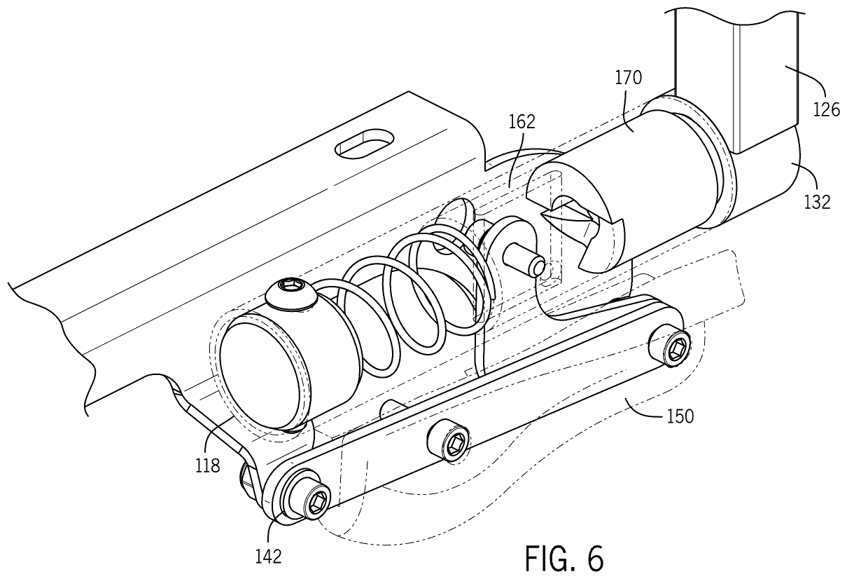

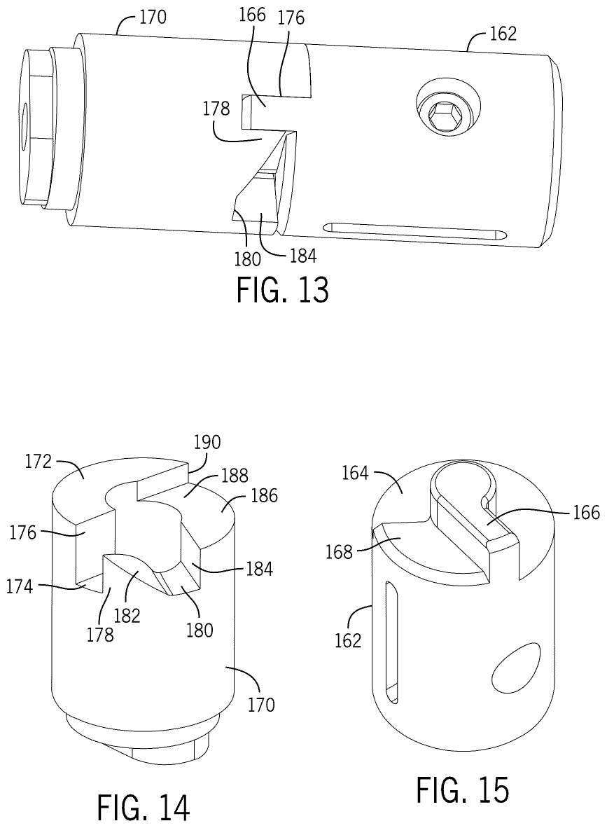

Within the housing 118, as shown in FIGS. 6 and 13-15, in the absence of activating the trigger assembly 140, an expanding coil spring 160, positioned adjacent the second end 124 of the housing 118, drives a push rod 162 axially towards the opposing front end 122 of the housing 118. The push rod 162 is inhibited from rotation. As shown in detail in FIG. 15, the corresponding front surface 164 of the push rod 162 includes a raised step 166 and an elevated reinforcing surface 168 having a height greater than the front surface 164 but less than the raised step 166, and disposed between the front surface 164 and step 166. The push rod 162 is configured to adjustably engage a corresponding gear 170, which is rotatable with the arm 126 as shown in FIG. 13. More specifically, the rear surface 172 of the gear 170 include a plurality of recesses in which to form a mechanical engagement with the step 166 of the push rod 162, corresponding to the three configurations of the arm 126, namely: Up Position, Out Position and Down Position. As shown in FIG. 14, the rear surface 172 of the gear 170 includes a first recess 174 defined between a stop surface 176 and a side wall of a step 178. When the step 166 of push rod 162 is positioned within the first recess 174, as shown in FIGS. 6, 7 and 13 the arm 126 is in the corresponding Up Position. The side wall of the first step 178 and stop surface 176 being generally parallel to the sides of the step 166 inhibit rotational movement of the arm 126 out of the Up Position in the absence of activating the trigger assembly 140. The stop surface 176 inhibits rotational movement of the arm 126 past the Up position even when activating the trigger assembly 140. Continuing, the rear surface 172 of the gear 170 further includes a second recess 180 defined between the inclined plane 182 of the first step 178 and an opposing side wall 184 of a second step 186. When the step 166 of push rod 162 is positioned within the second recess 180, the arm 126 is in the corresponding Out Position. Travel of the step 166 along the inclined plane 182 of the first step 178 allows the arm 126 to rotate upwardly into the Up Position, from the Out Position, in the absence of activating the trigger assembly 140, while the stop surface 184 being generally parallel to the side of the step 166 inhibit rotational movement of the arm 126 downwardly from the Out Position into the Down Position in the absence of activating the trigger assembly 140. Finally, the rear surface 172 of the gear 170 further includes a top surface 188 of the second step 186, which is defined between the second recess 182 and an opposing second stop surface 190. When the step 166 of push rod 162 is positioned on the top surface 188 of the second step 186, the arm 126 is in the corresponding Down Position. Travel of the step 166 along the top surface 188 and into the lower second recess 180 without obstruction allows the arm 126 to rotate upwardly into the Out Position, from the Down Position, in the absence of activating the trigger assembly 140, while the stop surface 190 being generally parallel to the side of the step 166 inhibit rotational movement of the arm 126 downwardly past the Down Position. In sum, active mechanical engagement of the step 166 of the push rod 162 with the surfaces 174, 180 and 188 of the gear from a one-directional ratchet lock within the housing 118. As described above, the ratchet according to one embodiment of the present invention is configured to have three configurations, corresponding to namely: Up Position, Out Position and Down Position. However, it should be understood that the present invention is not so limited and any number of configurations or positions is conserved well within the scope of the present invention. For example, in an alternative embodiment, the rear surface 172 of the gear may possess more or less than 3 surfaces for receiving the step 166 of the push rod. It is also considered within the scope of the present invention that the ratchet mechanism of the handle assembly be bi-directional rather than unidirectional.

During use, the upward pressure applied to the trigger handle 154, pivots the linkage 142 upwardly about its rear pivot point at the first end 144. This upward pivot of the linkage 142 translates to a rearward travel of the second end 152 of the connecting cam 150, located within the housing 118. The rearward travel of the second end 152 overcomes the expansion force of the coil spring 160, and rearwardly pulls the push rod 162 out of mechanical engagement with the recessed 174, 180 on the gear 170. In this released position, gravity is free to act upon the arm 126 and grip 130 such that the arm 126 may downwardly rotate from the Up Position towards the Down Position. In one embodiment, the center of mass of the arm 126 in the Up Position is not entirely perpendicular to the base of support upon which the wheelchair 10 rests, but is preferably less than 5°, and more preferably less than 3° from upright and is angled outward from the seat. In this slightly askew configuration of the Up Position, the grip 130 and arm 126 remain susceptible to gravitation forces to drive downward rotation upon activation of the trigger assembly 140, such that the grip will not remain balanced atop the Up Position upon activation of the trigger assembly 140.

Turning now to FIGS. 8 and 9, an alternative embodiment of handle assembly 200 is shown, in which like numbers correspond to like structures from the preceding embodiment of the handle assembly 100, with the addition of the number “200”. Specifically, as it relates to mounting bar 202, the handle assembly 200 further includes a first attachment tab 214 that is comprised in part of an adjustable length plate 215 defining a wheelchair arm receiving surface 217 at a bottom end. A channel 219 extends along the length of the plate 215 and overlies an aperture 221 disposed within the first attachment tab 214, such that a secured fastener may pass through both the first attachment tab 214 and plate 215. In this embodiment, the height of the receiving surface 217 may be securely adjusted to receive an arm tube 39 of the wheelchair 10 therein.

Furthermore, as it relates to arm 226, the linear portion of the arm 226 nearest the second end 232 may also comprise a two-part construction, including slidable plate 227 having a channel 229 extending along the length of the slidable plate 227 and configured to receive a fastener(s) through both the channel 229 the linear portion of the arm 226 nearest the second end 232. In this embodiment, the length of the channel 229 the linear portion of the arm 226 nearest the second end 232 may be securely adjusted to provide the user with a custom length arm 226.

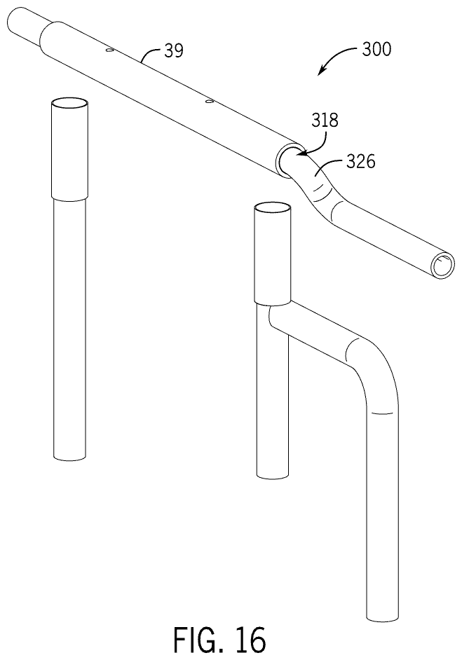

Finally, turning now to FIG. 16, an alternative embodiment of handle assembly 300 is shown in-part, in which like numbers correspond to like structures from the preceding embodiment of the handle assembly 100, with the addition of the number “300”. Specifically, in the embodiment of handle assembly 300, the mounting bar has been eliminated and the housing 318 has been built directly into the arm bar 39 of a wheelchair 10 to which the arm rests 38 are mounted. That is to say that the arm member or tube 39 may include front or first portion that defines a housing 318 that is coaxially aligned and contiguous with the rear or second portion that defines an upper exterior surface being an arm rest. More specifically, the housing 318 may be defined by the front inner wall of the arm member or tube and the arm rest may be defined by the upper exterior surface thereof. In such an embodiment, arm 326 of the handle assembly 300 extends directly from the forward end of the wheelchair arm bar 39 to provide greater integration of the handle assembly 300 into wheelchair 10. This embodiment provides for an arm rest 38 with an integrated handle assembly 300.

It should be further understood that the use and installation of the handle assembly 100, 200, 300, does not interfere with the manual activation of the wheelchair brakes 31. That is to say that a user may still manually engage the wheelchair brake 31 in the wheelchair 10 when the handle assembly 100 is in any configuration. Similarly, the handle assembly 100, 200, 300, does not interfere with the user's ability to access the hand rims located at the outer sides of the opposing wheels 12, 14 of the wheelchair 10, for use in self-propulsion.

Many other changes and modifications could be made to the invention without departing from the spirit thereof. For example, while the preceding description discloses the use the handle assemblies 100, 200, 300, in combination with a wheelchair 10, it is well within the scope of the present invention that the handle assemblies 100, 200, 300, may be used in combination with other ingress/egress embodiments, including but not limited to stationary chairs, desk chairs, and commodes. Furthermore, it should be understood that any of the features of the embodiments described herein may be alternated or swapped with one another, and are fully considered within the scope of the present invention.

We claim:

1. A stand assist mechanism configured to assist a user sitting into and/or rising from a wheelchair, comprising:
a wheelchair frame;
a seat affixed to the frame and configured for supporting an individual;
a first and second wheel attached to the frame at left and right transversely opposed sides of the seat surface supporting the frame and positioned for rotation by the individual;
a first arm member engaging the frame inwardly of the first wheel and a second arm member engaging the frame inwardly of the second wheel,
a first and second handle assembly, each assembly comprising:
a mounting surface engaging the respective first or second arm member of the wheelchair,
the mounting surface affixed to a housing,
a pivotable arm extending from the housing to a user grip, wherein the pivotable arm is configured to rotate about a longitudinal axis of the housing,
a ratchet lock disposed within the housing configured to engage the pivotable arm extending from the housing, and
a linkage configured to selectively disengage the ratchet lock upon user activation.

2. The stand assist mechanism of claim 1, wherein the pivotable arm is configured to rotate through a range of motion of less than or equal to 180°.

3. The stand assist mechanism of claim 2, where the range of motion is less than 180° and more than or equal to 170°.

4. The stand assist mechanism 2, wherein the pivotable arm has at least three locking positions within the range of motion.

5. The stand assist mechanism 4, wherein a first position of the at least three locking positions is a raised position in which the user grip is disposed at a height greater than a height of the arm member of the wheelchair.

6. The stand assist mechanism of claim 5, wherein a second position of the at least three locking positions is an outer position in which the user grip is disposed distally of the arm member of the wheelchair.

7. The stand assist mechanism of claim 6, wherein a third position of the at least three locking positions is a lowered position in which the user grip is disposed at a height less than the height of the arm member.

8. The stand assist mechanism of claim 7, further comprising a trigger in mechanical engagement with the linkage, wherein user activation of the trigger selectively disengages the ratchet lock as to allow the pivot arm to rotate from the first position to the second position, or the second position to the third position under gravitational force.

9. The stand assist mechanism of claim 7, wherein an upward rotational applied user force on the user grip is configured to overcome the ratchet lock as to allow the pivot arm to rotate from the third position to the second position, or the second position to the first position.

10. The stand assist mechanism of claim 6, wherein the user grip has a first grip surface configured to be grasped by a user hand when the pivotable arm is in the first position and a second grip surface configured to be grasped by a user hand when the pivotable arm is in the second position.

11. The stand assist mechanism of claim 1, wherein a length of the pivotable arm is telescopically adjustable.

12. The stand assist mechanism of claim 1, further comprising a protective finger shroud disposed in part between the housing and the arm member.

13. A stand assist arm rest assembly configured to assist a user sitting into and/or rising from a wheelchair, comprising:
a first arm configured to releasably engaging a wheelchair frame of inwardly of a first wheel and a second arm configured to engaging the wheelchair frame inwardly of a second wheel,
each of the first and second arms comprising:
an arm member, wherein an upper exterior surface of the arm member defines an arm rest,
one or more arm mounts extending downwardly from the arm member and configured to releasably engage the wheelchair frame,
a housing extending from the arm member;
a pivotable arm extending from a first end of the housing to a user grip, wherein the pivotable arm is configured to rotate about a longitudinal axis of the housing;
a ratchet lock disposed within the housing configured to engage the pivotable arm extending from the arm tube, and
a linkage configured to selectively disengage the ratchet lock upon user activation.

14. The stand assist arm rest assembly of claim 13, further comprising an arm tube wherein the arm member defines a rearward portion of the arm tube and the housing defines a front portion of the arm tube.

15. The stand assist arm rest assembly of claim 13, wherein the pivotable arm is configured to rotate through a range of motion of less than or equal to 180°.

16. The stand assist arm rest assembly 13, wherein the pivotable arm has at least three locking positions within the range of motion.

17. The stand assist arm rest assembly 16, wherein the at least three locking positions comprise:
a first position being a raised position in which the user grip is disposed at a height greater than a height of the arm tube when the first or second arm is engaging a wheelchair frame;
a second position being an outer position in which the user grip is disposed distally of the arm tube when the first or second arm is engaging a wheelchair frame; and,
a third position being a lowered position in which the user grip is disposed at a height less than the height of the arm tube when the first or second arm is engaging a wheelchair frame.

18. The stand assist arm rest assembly of claim 17, further comprising a trigger in mechanical engagement with the linkage, wherein user activation of the trigger selectively disengages the ratchet lock as to allow the pivot arm to rotate from the first position to the second position, or the second position to the third position under gravitational force.

19. The stand assist arm rest assembly of claim 17, wherein an upward rotational applied user force on the user grip is configured to overcome the ratchet lock as to allow the pivot arm to rotate from the third position to the second position, or the second position to the first position.

20. The stand assist arm rest assembly of claim 17, wherein the user grip has a first grip surface configured to be grasped by a user hand when the pivotable arm is in the first position and a second grip surface configured to be grasped by a user hand when the pivotable arm is in the second position.

21. A wheelchair assembly, comprising:
a wheelchair frame;
a seat affixed to the frame and configured for supporting an individual;
a first and second wheel attached to the frame at left and right transversely opposed sides of the seat surface supporting the frame and positioned for rotation by the individual;
a first arm member engaging the frame inwardly of the first wheel and a second arm member engaging the frame inwardly of the second wheel,
a first and second handle assembly, each assembly comprising:
a mounting surface engaging the respective first or second arm member of the wheelchair,
the mounting surface affixed to a housing,
a pivotable arm extending from the housing to a user grip, wherein the pivotable arm is configured to rotate about a longitudinal axis of the housing through a range of motion of less than or equal to 180°;
a ratchet lock disposed within the housing configured to engage the pivotable arm extending from the housing and provide the pivotable arm with at least three locking positions within the range of motion, the at least three locking positions comprising:
a first position being a raised position in which the user grip is disposed at a height greater than a height of the arm member;
a second position being an outer position in which the user grip is disposed distally of the arm member; and,
a third position being a lowered position in which the user grip is disposed at a height less than the height of the arm member;
and
a linkage configured to selectively disengage the ratchet lock upon user activation.
